(19) United States
(12) Patent Application Publication
(10) Pub. No.: US 2010/0257982 A1
(43) Pub. Date: Oct. 14, 2010

(54) TOOL HOLDER

(75) Inventors: Martin Brönnimann, Itingen (CH); Werner Freiner, Fullinsdorf (CH)

Correspondence Address: HAMMER & ASSOCIATES, P.C., 3125 SPRINGBANK LANE, SUITE G, CHARLOTTE, NC, 28226, US

(73) Assignee: Rego-Fix AG

(21) Appl. No.: 12/758,872

(22) Filed: Apr. 13, 2010

(30) Foreign Application Priority Data
Apr. 14, 2009 (CH) 00583/09

(51) Int. Cl. B23B 29/04

(52) U.S. Cl. 82/158; 279/44

(57) ABSTRACT

The tool holder for machine tools with fixed tools has a cylindrical shank for connection to the carriage or turret of the machine tool and a receiving bore for a tool. It comprises a base holder having the cylindrical shank and a collet chuck holder separate from the base holder and connectable to it with an exact fit and having a receiving bore for a collet chuck.

### FIELD OF THE INVENTION

The invention relates to a tool holder for machine tools with fixed tools, having a cylindrical shank for connection to the carriage or turret of the machine tool and having a receiving bore for a tool.

### BACKGROUND OF THE INVENTION

CNC lathes combine the advantages of all universal lathes. They often have an additional auxiliary axis, which is generally assigned as the axis of rotation of the work spindle. Each feed axis has its own motor and a position-measuring system. The tool carriage can receive a rotatable tool turret and is guided separately from the steady rest and tailstock, in order to traverse independently of them. The machine bed is usually laterally inclined by approx. 30° to enable better removal of chips. Only the planning outlay and the costs for single-piece production of simple parts are in some cases higher than with mechanically controlled alternatives.

If a plurality of tools are mounted on the carriage in a rotatable device, the turret head, the machine is called a turret lathe. The turret tool carriage comprises the bed slide, cross slide and turret head. In the case of the turret heads, a distinction is made, according to the orientation of the tool axis, between star or disc turrets with a vertical axis and drum turrets with a horizontal axis.

To machine the workpieces, the cutting tools (turning tools, drills, reamers, etc.) are fastened to the turret head by means of tool holders.

The most used tool holders are defined in the DIN ISO 10889 standard. The interface of these holders for reception in the turret are very inaccurate (large tolerances). As a result, on a change of cutting tool, the cutting edge has to be reset (centre height and horizontality) each time. In many automatic lathes, a device for performing this presetting is provided. During this setting for each individual tool (in some cases up to 30 tools on two turrets), the costly CNC lathe is idle. As soon as a cutting tool is blunt, it has to be changed again and thus set. The lathe is once again idle.

On the tool side, there are various clamping possibilities. The following clamping holders are employed: square longitudinal, transverse and multiple holders, tool holders for indexable insert drills and boring bar holders with nominal bore and 2-3 transverse screws for clamping, Morse taper holders, etc. When setting the cutting edge (centre height and horizontality), displacements may occur when tightening the locking screws (transverse screws), which makes precise adjustment difficult.

Tool holders provided with a collet chuck holder are also known. With these, a length offset arises when tightening a collet chuck in the collet chuck holder, which makes adjustment difficult.

The interface between tool holder and tool is thus likewise a cause of undesired downtimes of the machine.

The object on which the invention is based is to eliminate the disadvantages of known tool holders and thus, on the one hand, reduce the downtimes of the machines and, on the other hand, simplify the setting of the tools.

### SUMMARY OF THE INVENTION

According to the invention, this is achieved in that the tool holder comprises a base holder having the cylindrical shank and a collet chuck holder separate from the base holder and connectable to it with an exact fit and having a receiving bore for a collet chuck.

According to the invention, it is therefore proposed to introduce a further interface, through which the interface between tool holder and carriage or turret does not have to be separated during a tool change and thus its setting can remain unchanged, and the interface between tool holder and tool can be preset, so that no significant downtimes arise during the tool change. The additional interface is designed with negligible tolerances, so that all settings are exactly preserved.

### BRIEF DESCRIPTION OF THE DRAWINGS

A preferred exemplary embodiment of the invention is described below with the aid of the accompanying drawings, in which:

FIG. 1 shows a two-part tool holder with inserted turning tool, partially in section,

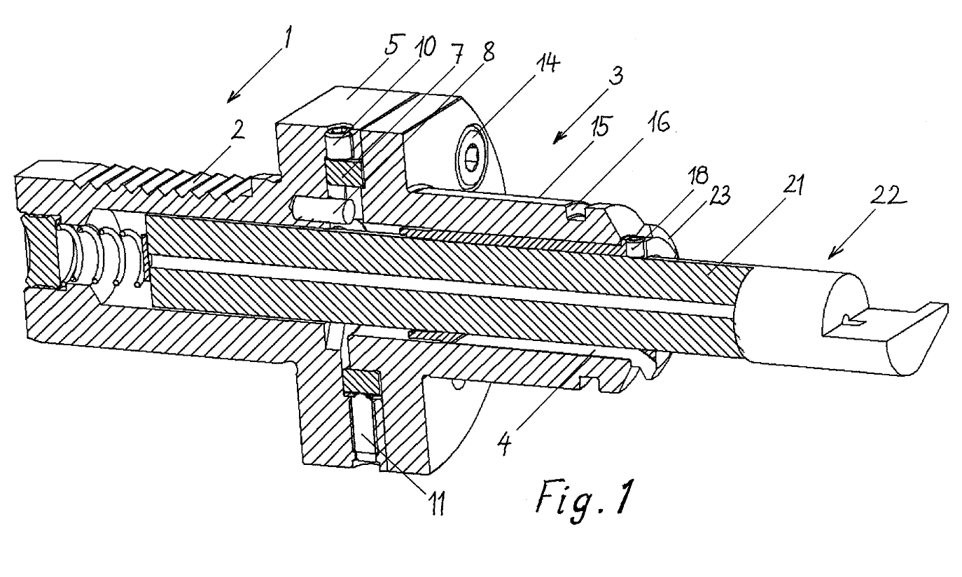

FIG. 2 shows the tool holder according to FIG. 1 with the parts separated.

### DETAILED DESCRIPTION OF THE DRAWINGS

The tool holder shown in the figures comprises two parts: a machine-side base holder (VDI holder) 1, having a cylindrical shank 2 for insertion into a receptacle of the carriage or turret of an automatic lathe, and a tool-side collet chuck holder 3, into which a collet chuck 4 can be inserted.

The base holder (VDI) has on the tool side a flange 5, in the end side of which a concentric recess 6 is provided. Arranged in the recess is an adjusting ring 7, the outside diameter of which is slightly smaller than the inside diameter of the recess. The adjusting ring is held in the recess by two axial locking screws 9.

In the flange there are arranged in the radial direction two adjusting screws 10, offset by 90°, and two ball plungers 11, each offset by a further 90°. The adjusting screws press on the lateral surface, and the ball plungers engage in a transverse groove. The transverse groove prevents rotation of the ring 7 when tightening the collet chuck holder.

Inside the adjusting ring there is arranged in the flange 5 an axially directed adjusting pin 8, which serves to fix the tool holder in a base holder (VDI) after the presetting. The effect achieved by this is that the centre height of the tool after screwing to the base holder in the machine is correct again.

The collet chuck holder is provided, on the machine side, with a flange 12 which, for its part, has on its end side a projecting fitting cylinder 13. The fitting cylinder has, at the place lying opposite the adjusting pin during assembly, a recess 24 up to the end face of the flange 12. In the flange there are provided four fastening screws 14 for tightening on the base holder. As for the rest, the collet chuck holder comprises an elongated cylindrical part 15 having an annular groove 16, arranged in the vicinity of the tool-side end and intended for engagement of the pressing jaws of a pressing tool known per se, and a receiving bore 17, narrowed conically towards the machine side and intended for receiving a collet chuck 4. By means of a radial locking screw 18, a boring bar or a cutting tool is tightened in a horizontally defined manner.

For adjustment, firstly the base holder is clamped in the lathe turret. After that, using the adjusting device of the lathe, the adjusting ring is preset by the adjusting screws 10 against the counterpressure of the respectively opposite ball plungers and fixed by the locking screws 9. The ring can thus be adjusted using only two screws.

As soon as the ring is adjusted and is fastened by locking screws, the collet chuck holder can be inserted. The fitting cylinder positions the collet chuck holder centrally by means of the preset adjusting ring of the base holder and radially by means of the adjusting pin 8 in the recess 24 in the flange 12.

The adjusting ring 7 can be readjusted even if the collet chuck holder has already been clamped. For this, it is necessary to release the locking screws 9 of the adjusting ring, through the two bores in the collet chuck holder flange, and the four fastening screws 14 of the collet chuck holder. After that, the adjusting ring can be readjusted by means of the measuring device of the automatic lathe.

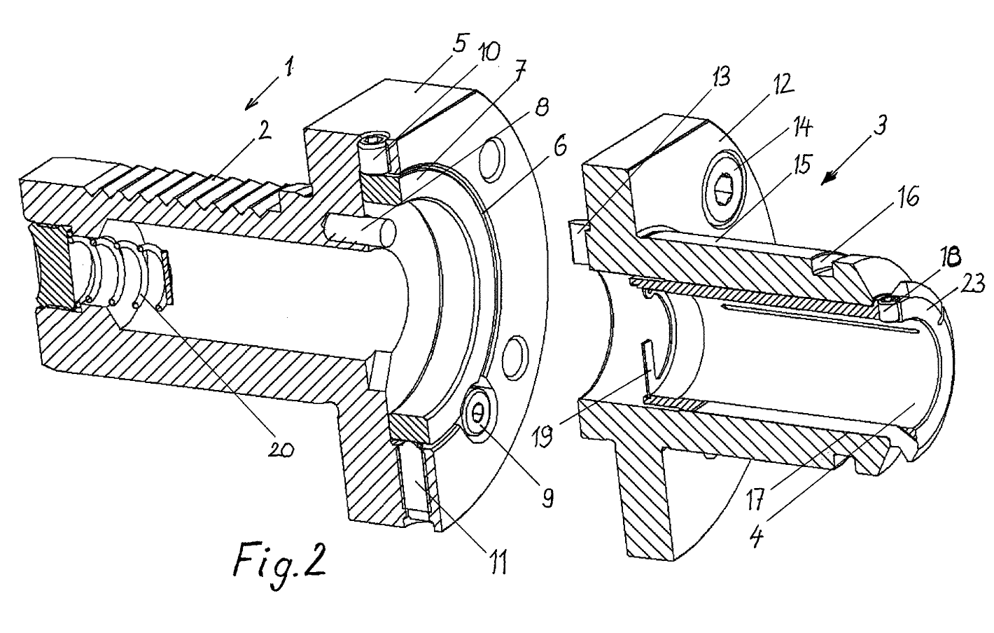

The collet chuck shown in FIG. 2 is provided with a securing plate 18 having openings for a coolant, which plate prevents the cutting tool shank from resting on the bottom of the blind bore of the base holder during the procedure of pressing the collet chuck into the collet chuck holder. This may be necessary when using the collet chuck holder on another base device without a through-bore. In the variant shown in FIG. 2, the securing plate may be omitted, since as a safeguard a spiral spring 19 keeps the cutting tool shank at a distance from the bottom of the blind bore.

The collet chuck 4 has, in correspondence with the known prior art, a cylindrical bore 20 for receiving a shank 21 of a tool 22, for example a turning tool, and a head with a flange 23 for attachment of the pressing jaws of the pressing tool. Its machine-side outer surface is conically tapered in correspondence with the cone angle of the receiving bore 17.

In the present description, cone angle or conicity refers to the opening angle of the cone, i.e. the angle between mutually opposite generatrices or surface lines of the conical surface and its axis. This cone angle is less than the so-called self-locking angle of approx. 5°, preferably less than 2°, in the exemplary embodiment described here.

The tool holder according to the invention is not limited to embodiments in which the collet chuck holder is coaxially connected to the base holder. For tool holders in which the tool is radially seated in the holder, i.e. with its axis perpendicular to the receptacle in the turret, the solution according to the invention with an additional interface can be employed in the same way.

1. A tool holder for machine tools with fixed tools, having a cylindrical shank for connection to the carriage or turret of the machine tool and having a receiving bore for a tool, characterised in that the tool holder comprising:
a base holder having said cylindrical shank; and
a collet chuck holder separate from said base holder and connectable to said base holder with an exact fit and having a receiving bore for a collet chuck.

2. The tool holder according to claim 1, characterised in that said base holder being provided with a first flange, arranged on the tool side, for connection to said collet chuck holder and in said flange there being arranged an adjusting ring adjustable by means of radial adjusting screws.

3. The tool holder according to claim 2, characterised in that said collet chuck holder being provided with a second flange arranged on the machine side and having a fitting cylinder for engagement in said adjusting ring with an exact fit.

4. The tool holder according to claim 1, characterised in that a cone angle of said collet chuck holder and of said collet chuck being less than a so-called self-locking angle of approximately 5°.

5. The tool holder according to claim 4, characterized in that said cone angle of said collet chuck holder and of said collet chuck being less than approximately 2°.
